(19) United States
(12) Patent Application Publication
(10) Pub. No.: US 2008/0057274 A1
(43) Pub. Date: Mar. 6, 2008

(54) MICRO-CHANNEL CHIP AND A PROCESS FOR PRODUCING THE SAME

(75) Inventors: Hisashi Hagiwara, Sagamihara-shi (JP); Yoshinori Mishina, Sagamihara-shi (JP)

Correspondence Address: DARBY & DARBY P.C., P.O. BOX 770, Church Street Station, New York, NY, 10008-0770, US

(73) Assignee: Aida Engineering, Ltd., Sagamihara-shi (JP)

(21) Appl. No.: 11/751,763

(22) Filed: May 22, 2007

(30) Foreign Application Priority Data
May 22, 2006 (JP) 2006-141235

(51) Int. Cl. B32B 3/00; B05D 5/12; C23F 1/00

(52) U.S. Cl. 428/172; 216/49; 427/98.4

(57) ABSTRACT

A micro-channel chip comprising at least an upper substrate, a lower substrate, and an intermediate substrate interposed between the upper substrate and the lower substrate, at least one non-adhesive thin-film layer for a micro-channel being linearly formed on one mating side which is selected from among the mating sides of the upper substrate and the intermediate substrate and the mating sides of the lower substrate and the intermediate substrate, at least two ports being provided on the non-adhesive thin-film layer for a micro-channel, at least one non-adhesive thin-film layer for a shutter channel being linearly formed on the mating side opposite the mating side on which the non-adhesive thin-film layer for a micro-channel is formed such that it intersects the non-adhesive thin-film layer for a micro-channel by passing beneath or over the latter, with the intermediate substrate lying in between, and a pressure supply port for inflating that part of the substrate which corresponds to the non-adhesive thin-film layer for a shutter channel being provided in at least one area on the non-adhesive thin-film layer for a shutter channel.

### INCORPORATION BY REFERENCE

The present application claims priority under 35 U.S.C. §119 to Japanese Patent Application No. 2006-141235 filed on May 22, 2006. The content of the application is incorporated herein by reference in its entirety.

### FIELD OF THE INVENTION

The present invention relates to a micro-channel chip having a micro-fluid control element. More particularly, the present invention relates to a micro-channel chip having a micro-fluid control element that functions as a valve mechanism for controlling the flow of a fluid within a micro-channel.

### BACKGROUND

Devices commonly known as “micro-total analysis systems (PTAS)” or “lab-on-chip” comprise a substrate and micro-structures such as micro-channels and ports that are provided in the substrate to form channels of specified shapes. It has recently been proposed that a variety of operations such as chemical reaction, synthesis, purification, extraction, generation and/or analysis be performed on substances in the micro-structures. Structures that are fabricated for this purpose and which have micro-structures such as micro-channels and ports provided in the substrate are collectively referred to as “micro-channel chips” or “micro-fluid devices.”

Micro-channel chips find use in a wide range of applications including gene analysis, clinical diagnosis, drug screening and environmental monitoring. Compared to devices of the same type in usual size, micro-channel chips have various advantages including (1) extremely smaller amounts of samples and reagents that need to be used, (2) shorter analysis time, (3) higher sensitivity, (4) portability to the site for on-site analysis, and (5) one-way use.

A conventional micro-channel chip is shown in FIGS. 7A and 7B, where it is indicated by numeral 100. As shown, the micro-channel chip 100 comprises an upper substrate 102 that is formed of a material such as a synthetic resin, at least one micro-channel 104 formed in the upper substrate 102, ports 105 and 106 formed in at least one end of the micro-channel 104 to serve as an input port and an output port, and a lower substrate 108 that is adhered to the lower side of the upper substrate 102 and which is formed of a transparent or opaque material (for example, glass or a synthetic resin film). The lower substrate 108 helps seal the bottoms of the ports 105 and 106, as well as the micro-channel 104. The materials and structures of micro-channel chips of the type shown in FIGS. 7A and 7B, as well as processes for producing them may be found in JP 2001-157855 A and U.S. Pat. No. 5,965,237, which are incorporated herein by reference.

Micro-channel chips of the type described above are sometimes equipped with a micro-valve or various other kinds of micro-fluid control mechanisms (also called “micro-fluid control elements”) which are provided halfway down the micro-channel in order to control the flow of a continuous fluid (such as liquid or gas) or the transfer of tiny droplets. Examples of such micro-fluid control mechanisms may be found in JP 2000-27813 A and Japanese Patent No. 3418727, which are incorporated herein by reference.

The micro-fluid control mechanism described in JP 2000-27813 A has a liquid-repelling fine tube connected to a main channel (micro-channel) responsible for liquid movement and forces a gas into the main channel through the fine tube or suctions the gas in the main channel so that the pressure of the gas in the main channel is rendered either positive or negative, whereby a liquid is pushed or pulled to achieve the intended liquid movement. The liquid-repelling fine tube described in JP 2000-27813 A has inner surfaces that tend to repel the liquid so that it will not get into the fine tube even if a certain amount of pressure is exerted. As a result, if the gas is suctioned, the liquid will move up to a point near the inlet of the fine tube but it just stays there without moving any farther.

However, the micro-fluid control mechanism described in JP 2000-27813 A has the following problems.

(1) The Fine Tube is Difficult to Shape.

If the main channel has a rectangular cross section, it generally ranges from about 50 μm to about 500 μm in width and from about 10 μm to about 100 μm in height. On the other hand, the fine tube which is formed to block the passage of a liquid is much smaller than the main channel and both of its width and height need to be smaller than a few micrometers. Hence, from the micro-forming viewpoint, the channel through the fine tube must be shaped by a method that is even more sophisticated and expensive than is required to form the main channel. For instance, if lithography is used in micro-forming, a film mask is impracticable and an expensive glass mask must be employed.

(2) Channels cannot be Made Uniform in Height and it is Difficult to Fabricate the Intended Micro-Channel Chip.

Generally, micro-channel chips have such a structure that a substrate in which fine channels (grooves) are formed is attached to a substrate having a flat surface. In the case of forming fine channels as in a micro-channel chip, channels of equal height are easy to form but considerable difficulty is involved in fabricating channels of varying height. It is occasionally necessary to take a special measure such as forming the main channel and the fine tube in different substrates. But then the time required of substrate fabrication doubles and, what is more, the need to attach the two substrates together in high precision and other considerations that are introduced add to the difficulty involved in the fabrication of micro-channel chips.

(3) It is Difficult to Ensure that Only the Fine Tube Portion is Formed to have a Liquid-Repelling Nature.

The main channel should of course have affinity for liquid but the fine tube portion needs to repel liquid. With a fine structure, it is difficult to provide affinity for liquid in a part of the structure but make it repel liquid in another part.

(4) Dust May Cause Clogging.

If a liquid containing dust is suctioned through the fine tube, the dust might clog the inlet of the fine tube to make it no longer functional. The dust may be so small that it will not cause clogging in the main channel but it might cause a problem in the fine tube.

(5) Air Bubbles May Cause Clogging.

When a fluid is forced into the micro-channel through the inlet port, air bubbles may also get into the channel. These air bubbles might block the inlet of the fine tube, potentially depriving the fine tube of its ability to perform the intended function.

The micro-valve shown in FIG. 3 accompanying Japanese Patent No. 3418727 comprises two polydimethylsiloxane (PDMS) micro-channel chips and one membrane (valve), and it has a valve mechanism where the membrane (valve) that is displaced in the valve region detaches from or attaches to the valve seat, thereby opening or closing the working fluid channel. In addition, this micro-valve has a drive fluid channel that is formed in contact with the membrane (valve) and which has a pressure compartment where the pressure of a drive fluid is exerted in the valve region; by supplying the pressure of the drive fluid into the pressure compartment or withdrawing it from the pressure compartment, the membrane (valve) is displaced such that it is detached from or attached to the valve seat, whereupon it opens or closes as a one-way valve. However, the micro-valve described in Japanese Patent No. 3418727 is of such a structure that the membrane (valve) which is detached from or attached to the valve seat simply makes a one-way displacement toward the pressure compartment and, hence, the membrane (valve), when it is in OPEN mode, will have only an insufficient gap from the valve seat, making the fluid less flowable and pulsate. In addition, the valve itself has a complex structure comprising the pressure compartment, the valve seat, and the membrane (valve). It is by no means easy to provide such a complex structure halfway down the micro-channel.

### SUMMARY OF THE INVENTION

It is, therefore, an object of the present invention to provide a micro-channel chip having a micro-fluid control mechanism of an entirely novel structure that neither has the conventional groove-like structure nor requires a valve seat or a pressure compartment.

In one embodiment, the invention provides a micro-channel chip comprising at least an upper substrate, a lower substrate, and an intermediate substrate interposed between the upper substrate and the lower substrate, at least one non-adhesive thin-film layer for a micro-channel being linearly formed on one mating side which is selected from among the mating sides of the upper substrate and the intermediate substrate and the mating sides of the lower substrate and the intermediate substrate, at least two ports being provided in any positions on the non-adhesive thin-film layer for a micro-channel, at least one non-adhesive thin-film layer for a shutter channel being linearly formed on the mating side opposite the mating side on which the non-adhesive thin-film layer for a micro-channel is formed such that it intersects the non-adhesive thin-film layer for a micro-channel by passing beneath or over the latter, with the intermediate substrate lying in between, and a pressure supply port for inflating that part of the substrate which corresponds to the non-adhesive thin-film layer for a shutter channel being provided in at least one area on the non-adhesive thin-film layer for a shutter channel.

According to this embodiment, if a positive pressure is applied through one port on the non-adhesive thin-film layer for a micro-channel, that part of the substrate which corresponds to the non-adhesive thin-film layer for a micro-channel inflates to create a gap that can function as a micro-channel, whereupon it becomes possible to force a liquid and/or a gas from that port to the other port. If a positive pressure is applied through the pressure supply port on the non-adhesive thin-film layer for a shutter channel, that part of the intermediate substrate which corresponds to the non-adhesive thin-film layer for a micro-channel inflates to create a gap that can function as a shutter channel. Thus, by controlling the inflation of that part of the intermediate substrate which corresponds to the non-adhesive thin-film layer for a shutter channel, it can be operated to function as a micro-valve for opening or closing the upper micro-channel.

Another embodiment of the invention provides a micro-channel chip comprising at least an upper substrate, a lower substrate, and an intermediate substrate interposed between the upper substrate and the lower substrate, at least one groove-like micro-channel with a fixed cross-sectional shape being formed on one mating side selected from among the sides of the upper substrate and the intermediate substrate and the mating sides of the lower substrate and the intermediate substrate, at least two ports being provided in any positions on the micro-channel, at least one non-adhesive thin-film layer for a shutter channel being linearly formed on the mating side opposite the mating side on which the micro-channel is formed such that it intersects the micro-channel by passing beneath or over the latter, with the intermediate substrate lying in between, and a pressure supply port for inflating that part of the substrate which corresponds to the non-adhesive thin-film layer for a shutter channel being provided in at least one area on the non-adhesive thin-film layer for a shutter channel.

According to this embodiment, if a high positive pressure is applied through the pressure supply port on the non-adhesive thin-film layer for a shutter channel, that part of the intermediate substrate which corresponds to the non-adhesive thin-film layer for a shutter channel inflates to create a gap that can function as a shutter channel, whereupon the micro-channel having a fixed cross-sectional shape can be blocked. Thus, by controlling the inflation of that part of the intermediate substrate which corresponds to the non-adhesive thin-film layer for a shutter channel, it can be operated to function as a micro-valve for opening or closing the micro-channel having a fixed rectangular cross-sectional shape.

In another embodiment the linear, non-adhesive thin-film layer for a micro-channel may further include, halfway down it, at least one enlarged region having at least one planar shape that is selected from the group consisting of a circular, an elliptical, a rectangular, and a polygonal shape.

According to this invention, the enlarged region can function as a liquid reservoir or a reaction chamber, which can be utilized to ensure efficient performance of PCR amplification and other operations.

In still another embodiment the linear, non-adhesive thin-film layer for a micro-channel may be formed on the upper side of the intermediate substrate and the non-adhesive thin-film layer for a shutter channel is formed on the lower side of the intermediate substrate.

According to this embodiment, the linear, non-adhesive thin-film layer for a micro-channel and the non-adhesive thin-film layer for a shutter channel can be simultaneously formed on opposite sides of the same member, so the time required to achieve alignment when providing the two non-adhesive thin-film layers to intersect each other can be eliminated.

In yet another embodiment the upper substrate and the intermediate substrate may be made of silicone rubber whereas the lower substrate is made of silicone rubber or glass.

According to this embodiment, the upper substrate, the intermediate substrate and the lower substrate can be permanently bonded together without using an adhesive.

In another embodiment, the invention provides a process for producing the micro-channel chip, wherein the linear, non-adhesive thin-film layer for a micro-channel and/or the non-adhesive thin-film layer for a shutter channel may be formed by depositing on a substrate surface a thin film of a fluorocarbon (CHF3) through a mask having a desired through-pattern in the presence of the fluorocarbon using a reactive ion etching system (RIE).

According to this embodiment, the non-adhesive thin-film layer that follows the mask pattern can be formed by simply depositing it on the mating side of a desired substrate and, hence, the micro-channel chip can be produced not only at lower cost but also in higher yield.

Another embodiment of the invention provides a process for producing the micro-channel chip wherein the linear, non-adhesive thin-film layer for a micro-channel and/or the non-adhesive thin-film layer for a shutter channel is formed by printing on a substrate surface.

According to this embodiment, the non-adhesive thin-film layer is formed by printing, so the micro-channel chip can be produced not only at a much lower cost but also in a far higher yield.

According to the present invention, if a positive pressure is applied through the pressure supply port on the non-adhesive thin-film layer for a shutter channel, that part of the intermediate substrate which corresponds to the non-adhesive thin-film layer for a shutter channel inflates to create a gap that can function as a shutter channel to block the micro-channel. Thus, by controlling the inflation of that part of the intermediate substrate which corresponds to the non-adhesive thin-film layer for a shutter channel, it can be operated to function as a micro-valve for opening or closing the micro-channel. Therefore, the micro-valve which comprises the non-adhesive thin-film layer for a shutter channel according to the present invention is a completely novel fluid control element that far excels the conventional micro-valve not only structurally but also from an economic viewpoint.

### BRIEF DESCRIPTION OF THE DRAWINGS

FIG. 1A is an outline transparent plan view showing an example of the micro-channel chip according to the present invention.

FIG. 1B is an outline sectional view taken through FIG. 1A along line 1B-1B.

FIG. 1C is an outline sectional view taken through FIG. 1A along line 1C-1C.

FIG. 2 is an outline perspective view showing an example of the sequence of steps in assembling the micro-channel chip of the present invention.

FIG. 3A is a partial outline sectional view showing an exemplary mode of using the micro-channel chip of the present invention.

FIG. 3B is a partial outline sectional view showing how the micro-channel chip of FIG. 3A has slightly inflated only in the area where the non-adhesive thin-film layer 11 is provided to create a gap 18 that can function as a micro-channel.

FIG. 3C is a partial outline sectional view showing how the micro-channel chip of FIG. 3A has slightly inflated in the area where the non-adhesive thin-film layer 12 is provided to block the gap 18 that can function as a micro-channel.

FIG. 4A is a partial outline sectional view showing another embodiment of the micro-channel chip of the present invention, with the upper substrate having a micro-channel with a fixed rectangular shape.

FIG. 4B is a partial outline sectional view showing how the micro-channel chip of FIG. 4A has slightly inflated in the area where the non-adhesive thin-film layer 12 is provided to block the micro-channel having a fixed rectangular shape.

FIG. 5A is a flowchart showing the first half of a process for producing a micro-channel chip according to another embodiment of the present invention.

FIG. 5B is a flowchart showing second half of the process for producing the micro-channel chip.

FIG. 6(a) is an exploded view showing an example of the micro-channel chip according to yet another embodiment of the present invention that is used in Example 3, and FIG. 6(b) is a perspective view of the micro-channel chip in an assembled state.

FIG. 7A is an outline transparent plan view showing an example of the conventional micro-channel chip.

FIG. 7B is a sectional view taken through FIG. 7A along line 7B-7B.

### DETAILED DESCRIPTION

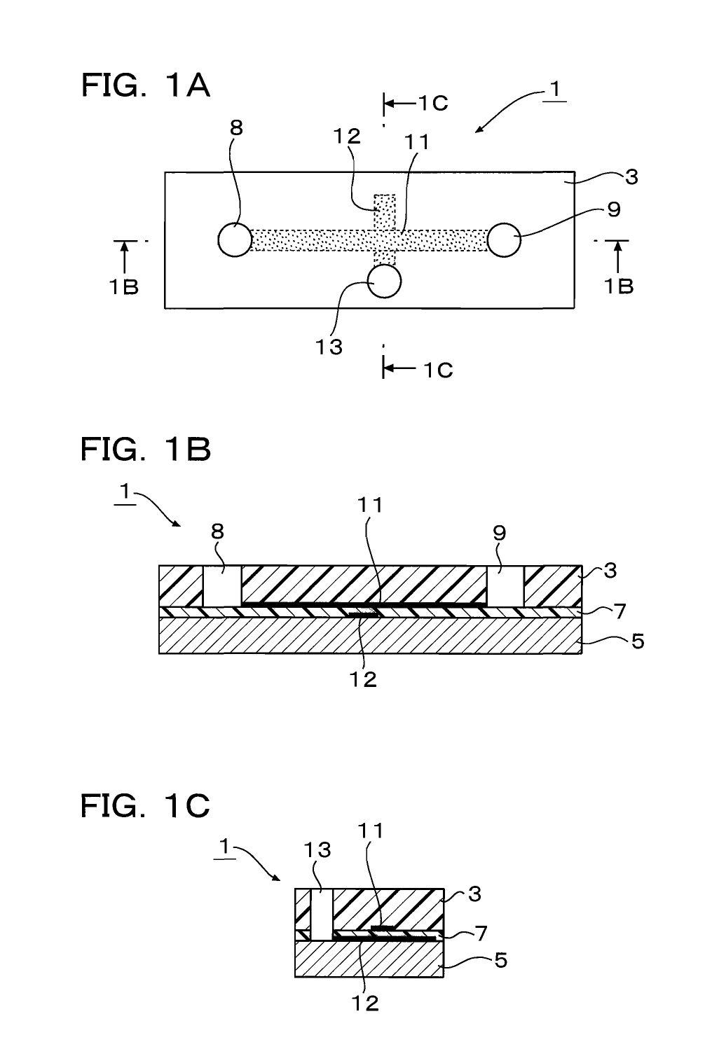

FIG. 1A is an outline transparent plan view showing an example of the micro-channel chip according to the present invention; FIG. 1B is a sectional view taken through FIG. 1A along line 1B-1B; and FIG. 1C is a sectional view taken through FIG. 1A along line 1C-1C. The micro-channel chip according to the present invention comprises basically an upper substrate 3, a lower substrate 5, and an intermediate substrate 7 interposed between the upper substrate 3 and the lower substrate 5. The upper substrate 3 has ports 8 and 9 provided in it that should serve as an inlet and an outlet for a medium such as a liquid or gas. The lower side of the upper substrate 3 has a non-adhesive thin-film layer for a micro-channel 11 provided in a specified area to cover a specified width and length. One end of the non-adhesive thin-film layer for a micro-channel 11 is connected to the port 8 and the other end to the port 9. The upper side of the lower substrate 5 has a non-adhesive thin-film layer for a micro-channel 12 provided in a specified area to cover a specified width and length. One end of the non-adhesive thin-film layer for a shutter channel 12 is connected to a pressure supply port 13. The non-adhesive thin-film layer for a shutter channel 12 must be provided in such a way that it intersects the non-adhesive thin-film layer for a micro-channel 11 by passing beneath or over the latter, with the intermediate substrate 7 lying in between. Unless the non-adhesive thin-film layer for a shutter channel 12 is provided in such a way that it intersects the non-adhesive thin-film layer for a micro-channel 11 by passing beneath or over the latter, with the intermediate substrate 7 lying in between, the non-adhesive thin-film layer for a shutter channel 12 will not be able to contribute to providing a micro-valve that opens or closes the non-adhesive thin-film layer for a micro-channel 11; for details, see below.

The ports 8 and 9 need not necessarily be provided at opposite ends of the non-adhesive thin-film layer for a micro-channel 11. At least two ports can be provided in arbitrary positions on the non-adhesive thin-film layer for a micro-channel 11. In addition, the pressure supply port need not necessarily be provided in an end portion of the non-adhesive thin-film layer for a shutter channel 12. At least one pressure supply port can be provided in an arbitrary position on the non-adhesive thin-film layer for a shutter channel 12. For instance, the pressure supply port may be provided in the central part of the non-adhesive thin-film layer for a shutter channel 12. It should also be mentioned that as long as a sufficient pressure to inflate a region corresponding to the non-adhesive thin-film layer for a shutter channel 12 can be supplied through the pressure supply port, this port need not necessarily be open to the atmosphere.

The upper substrate 3 and the intermediate substrate 7 adhere to each other except in areas that correspond to the non-adhesive thin-film layer for a micro-channel 11 and the ports 8 and 9. As will be explained below in detail, the non-adhesive thin-film layer for a micro-channel 11 is an area that should serve as a micro-channel in the conventional micro-channel chip. However, since the ports 8 and 9 are usually interrupted by the non-adhesive thin-film layer for a micro-channel 11, a medium such as a liquid or gas cannot be transferred from one port to the other. It should be noted here that an invention relating to a micro-channel chip that uses the non-adhesive thin-film layer 11 as a micro-channel was already filed by the assignee of the subject application as Japanese Patent Application 2006-037946.

The lower substrate 5 and the intermediate substrate 7 adhere to each other except in areas that correspond to the non-adhesive thin-film layer for a shutter channel 12 and the pressure supply port 13. As will be explained below in detail, the non-adhesive thin-film layer for a shutter channel 12 should serve as a fluid control element like a shutter channel in the micro-channel chip 1 of the present invention.

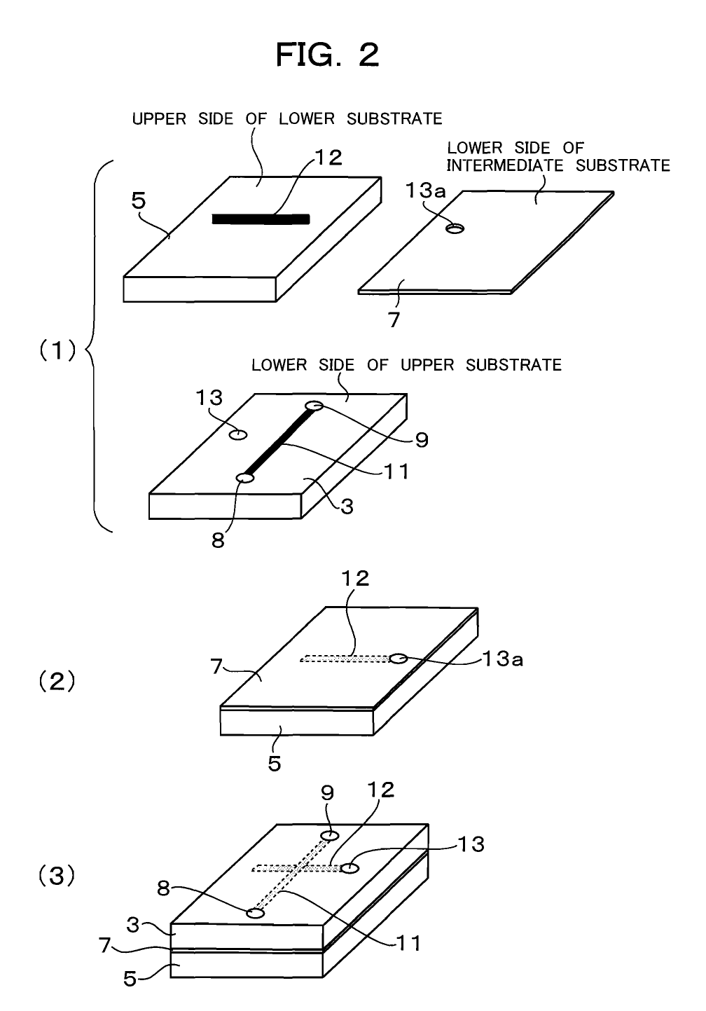

FIG. 2 is an exploded view that illustrates an example of the sequence of steps in fabricating the micro-channel chip 1 of the present invention. First, in step (1), the upper substrate 3, the lower substrate 5 and the intermediate substrate 7 are provided in preparation for constructing the micro-channel chip 1 of the present invention. The upper side of the lower substrate 5 has the non-adhesive thin-film layer for a micro-channel 12 provided in a specified area to cover a specified width and length. The intermediate substrate 7 has a through-hole 13a provided in a specified area. In addition, the lower side of the upper substrate 3 has the non-adhesive thin-film layer for a micro-channel 11 provided in a specified area to cover a specified width and length; it also has the ports 8 and 9 provided as through-holes in such a way that they communicate with opposite ends of the non-adhesive thin-film layer for a micro-channel 11; there is also the through-hole 13 that is provided in the position that corresponds to the through-hole 13a in the intermediate substrate 7. If desirable, the upper side of the lower substrate 5, both sides of the intermediate substrate 7, and the lower side of the upper substrate 3 may be treated for surface modification. By treatment for surface modification, the respective substrates can be adhered to each other with greater strength. As a treatment for surface modification, the oxygen plasma treatment, excimer UV light irradiation or the like can be employed. The oxygen plasma treatment can be performed in the presence of oxygen by means of a reactive ion etching (RIE) apparatus. Excimer UV light irradiation can be performed in the air at one atmosphere using a dielectric barrier discharge lamp, so it has the advantage of low treatment cost. Next, in step (2), the lower side of the intermediate substrate 7 is attached to the upper side of the lower substrate 5. Finally, in step (3), the lower side of the upper substrate 3 is attached to the upper side of the intermediate substrate 7, whereupon the micro-channel chip 1 of the present invention is completed.

The non-adhesive thin-film layer 11 and/or the non-adhesive thin-film layer 12 may be exemplified by the following that can be formed by known conventional techniques of chemical thin film formation: electrode film, dielectric protective film, semiconductor film, transparent conductive film, fluorescent film, superconductive film, dielectric film, solar cell film, anti-reflective film, wear-resistant film, optical interfering film, reflective film, antistatic film, conductive film, anti-fouling film, hard coating film, barrier film, electromagnetic wave shielding film, IR shield film, UV absorption film, lubricating film, shape-memory film, magnetic recording film, light-emitting device film, biocompatible film, corrosion-resistant film, catalytic film, gas sensor, etc.

These thin-film layers can typically be formed by an apparatus for plasma discharge treatment and the reactive gas may preferably be exemplified by organofluorine compounds and metal compounds.

Exemplary organofluorine compounds include: fluorocarbon compounds such as fluoromethane, fluoroethane, tetrafluoromethane, hexafluoroethane, 1,1,2,2-tetrafluoroethylene, 1,1,1,2,3,3,-hexafluoropropane, hexafluoropropane, and 6-fluoropropylene; fluorohydrocarbon compounds such as 1,1-difluoroethylene, 1,1,1,2-tetrafluoroethane, and 1,1,2,2,3-pentafluoropropane; chlorofluorohydrocarbon compounds such as difluorodichloromethane and trifluorochloromethane; fluoroalcohols such as 1,1,1,3,3,3-hexafluoro-2-propanol, 1,3-difluoro-2-propanol, and perfluorobutanol; fluorocarboxylate esters such as vinyl trifluoroacetate and 1,1,1-trifluoroacetate; and ketone fluorides such as acetyl fluoride, hexafluoroacetone, and 1,1,1-trifluoroacetone.

Exemplary metal compounds include elementary or alloyed metal compounds or organometallic compounds of Al, As, Au, B, Bi, Ca, Cd, Cr, Co, Cu, Fe, Ga, Ge, Hg, In, Li, Mg, Mn, Mo, Na, Ni, Pb, Pt, Rh, Sb, Se, Si, Sn, Ti, V, W, Y, Zn, Zr, etc.

Another chemical film forming technique that may be employed is the formation of a dense film by the sol-gel method and examples of the metal compounds that are preferred for use in this method include elementary or alloyed metal compounds or organometallic compounds of Al, As, Au, B, Bi, Ca, Cd, Cr, Co, Cu, Fe, Ga, Ge, Hg, In, Li, Mg, Mn, Mo, Na, Ni, Pb, Pt, Rh, Sb, Se, Si, Sn, Ti, V, W, Y, Zn, Zr, etc.

The non-adhesive thin-film layer 11 and/or the non-adhesive thin-film layer 12 may also be formed by a reactive ion etching system (RIE) in the presence of a fluorocarbon (CHF3) using a patterned mask. Other methods can of course be employed. For instance, the non-adhesive thin-film layer 11 and/or the non-adhesive thin-film layer 12 may be formed by printing techniques. For printing, a variety of known and conventional printing methods may be adopted, including roll printing, pattern printing, decalcomania, electrostatic duplication, and the like. When the non-adhesive thin-film layer 11 and/or the non-adhesive thin-film layer 12 are to be formed by printing techniques, various materials can advantageously be used to form the non-adhesive thin-film layer 11 and/or the non-adhesive thin-film layer 12 and they include: fine metal particles (for example, the fine particles of elementary metals or alloys thereof as selected from among Al, As, Au, B, Bi, Ca, Cd, Cr, Co, Cu, Fe, Ga, Ge, Hg, In, Li, Mg, Mn, Mo, Na, Ni, Pb, Pt, Rh, Sb, Se, Si, Sn, Ti, V, W, Y, Zn, Zr, etc. or the fine particles of oxides of these elementary metals or alloys thereof (e.g. fine ITO particles), and the fine particles of organometallic compounds of these metals), conductive ink, insulated ink, fine carbon particles, silanizing agent, parylene, coatings, pigments, dyes, water-based dye ink, water-based pigment ink, oil-based dye ink, oil-based pigment ink, solvent-based ink, solid ink, gel ink, polymer ink, and the like. The thickness of the printed layer may be approximately comparable to the thickness of the CHF3 film that is formed by the reactive ion etching system (RIE).

The non-adhesive thin-film layer 11 and/or the non-adhesive thin-film layer 12 preferably has a thickness in the range from 10 nm to 10 μm. If the thickness of the non-adhesive thin-film layer 11 and/or the non-adhesive thin-film layer 12 is less than 10 nm, these thin-film layers will not be formed uniformly but both adhering and non-adhering sites will be scattered about as islands and the non-adhesive thin-film layer 11 finds difficulty functioning to provide a micro-channel. If, on the other hand, the thickness of the non-adhesive thin-film layer 11 and/or the non-adhesive thin-film layer 12 is greater than 10 μm, not only is the non-adhering effect saturated but due the excessive thickness of these layers, two adjacent substrates also come apart at the border to the non-adhesive thin-film layer 11 or 12 and fail to be bonded effectively. This causes undesirable inconveniences such as the failure to maintain the exact width of the non-adhesive thin-film layer 11 and/or the non-adhesive thin-film layer 12. The thickness of the non-adhesive thin-film layer 11 and/or the non-adhesive thin-film layer 12 preferably ranges from about 50 nm to about 3 μm.

The width of the non-adhesive thin-film layer for a micro-channel 11 may be generally the same as or greater or even smaller than the width the micro-channel in the conventional micro-channel chip. Generally, the non-adhesive thin-film layer 11 has a width ranging from about 10 μm to about 3000 μm. If the width of the non-adhesive thin-film layer 11 is less than 10 μm, so high a pressure must be exerted to inflate the non-adhering portion for creating micro-channel that the micro-channel chip 1 itself might be destroyed. If, on the other hand, the width of the non-adhesive thin-film layer 11 exceeds 3000 μm, the channel that is formed by inflating over a width greater than 3000 μm will be saturated with an unduly large amount of substance although the micro-channel chip is inherently intended to transport and control very small amounts of liquid or gas and perform chemical reaction, synthesis, purification, extraction, generation and/or analysis on substances. The excessive width of the non-adhesive thin-film layer 11 will cause additional undesirable inconveniences such as the likelihood to impair the ability of the channel to prevent liquid deposition on its inner surfaces although this ability is one of the advantages of the channel structure obtained by inflating.

The non-adhesive thin-film layer for a shutter channel 12 may have the necessary and sufficient width to contribute to providing a micro-valve. Generally, the non-adhesive thin-film layer 12 has a width ranging from about 10 μm to about 5000 μm. If the width of the non-adhesive thin-film layer 12 is less than 10 μm, the micro-valve formed by inflating the non-adhering portion is so small in diameter that it will not be able to completely block the overlying micro-channel; in addition, so high a pressure must be exerted to create the micro-valve that the micro-channel chip 1 itself might be destroyed. If, on the other hand, the width of the non-adhesive thin-film layer 12 exceeds 5000 μm, it is unduly wide for the purpose of providing a micro-valve and diseconomy simply results.

The pattern of the non-adhesive thin-film layer 11 and/or the non-adhesive thin-film layer 12 is by no means limited to the illustrated linear form. In consideration of the object and/or use, the non-adhesive thin-film layer 11 and/or the non-adhesive thin-film layer 12 in Y-shaped, L-shaped or various other patterns may be adopted. In addition to the linear portion, the non-adhesive thin-film layer for a micro-channel 11 may also have an enlarged region in any planar shape, such as a circular, an elliptical, a rectangular, or a polygonal shape. The enlarged region can function as a liquid reservoir upon inflating; this liquid reservoir portion may be utilized to ensure efficient performance of PCR amplification and other operations.

The upper substrate 3 of the micro-channel chip 1 according to the present invention is preferably made of an elastic and/or flexible polymer or elastomer. If the upper substrate 3 is not formed of an elastic and/or flexible material, it becomes either impossible or difficult to ensure that the part of the upper substrate 3 which corresponds to the non-adhesive thin-film layer for a micro-channel 11 is sufficiently deformed to create a micro-channel of the type found in the conventional micro-channel chip. Hence, preferred materials of which the upper substrate 3 can be formed include not only silicone rubbers such as polydimethylsiloxane (PDMS) but also the following: nitrile rubber, hydrogenated nitrile rubber, fluorinated rubber, ethylene-propylene rubber, chloroprene rubber, acrylic rubber, butyl rubber, urethane rubber, chlorosulfonated polyethylene rubber, epichlorohydrin rubber, natural rubber, isoprene rubber, styrene-butadiene rubber, butadiene rubber, polysulfide rubber, norbornene rubber, and thermoplastic elastomers. Silicone rubbers such as polydimethylsiloxane (PDMS) are particularly preferred.

The thickness of the upper substrate 3 is within the range from 10 μm to 5 mm. If the thickness of the upper substrate 3 may be less than 10 μm, even a low pressure is sufficient for creating a micro-channel by inflating that part of the upper substrate 3 which corresponds to the non-adhesive thin-film layer 11 but, on the other hand, there is a high likelihood for the upper substrate 3 to rupture. If the thickness of the upper substrate 3 exceeds 5 mm, an undesirably high pressure must be exerted to create a micro-channel by inflating that part of the upper substrate 3 which corresponds to the non-adhesive thin-film layer 11.

The intermediate substrate 7 of the micro-channel chip 1 according to the present invention may be made of an elastic and/or flexible polymer or elastomer. If the intermediate substrate 7 is not formed of an elastic and/or flexible material, it becomes either impossible or difficult to ensure that the part of the intermediate substrate 7 which corresponds to the non-adhesive thin-film layer for a shutter channel 12 is sufficiently deformed to create a shutter channel that can function as a micro-valve. Hence, preferred materials of which the intermediate substrate 7 can be formed include not only silicone rubbers such as polydimethylsiloxane (PDMS) but also the following: nitrile rubber, hydrogenated nitrile rubber, fluorinated rubber, ethylene-propylene rubber, chloroprene rubber, acrylic rubber, butyl rubber, urethane rubber, chlorosulfonated polyethylene rubber, epichlorohydrin rubber, natural rubber, isoprene rubber, styrene-butadiene rubber, butadiene rubber, polysulfide rubber, norbornene rubber, and thermoplastic elastomers. Silicone rubbers such as polydimethylsiloxane (PDMS) are particularly preferred. If the upper substrate 3 is formed of PDMS, it is preferred that the intermediate substrate 7 is also formed of PDMS. This is because two members of PDMS can either bond permanently or undergo self-adsorption on each other without using any adhesive.

The thickness of the intermediate substrate 7 may be within the range from 10 μm to 500 μm. If the thickness of the intermediate substrate 7 is less than 10 μm, even a low pressure is sufficient for creating a micro-valve by inflating that part of the intermediate substrate 7 which corresponds to the non-adhesive thin-film layer 12 but, on the other hand, there is a high likelihood for the intermediate substrate 7 to rupture. If the thickness of the intermediate substrate 7 exceeds 500 μm, an undesirably high pressure must be exerted to create a micro-valve by inflating that part of the intermediate substrate 7 which corresponds to the non-adhesive thin-film layer 12.

The lower substrate 5 of the micro-channel chip 1 according to the present invention has no particular need to be elastic and/or flexible but it is preferred that it can be strongly adhered to the intermediate substrate 7. Suppose the case where the intermediate substrate 7 is made of a silicone rubber such as polydimethylsiloxane (PDMS); if the lower substrate 5 is made of a silicone rubber such as PDMS or glass, the intermediate substrate 7 and the lower substrate 5 can be strongly adhered to each other without using an adhesive. This phenomenon is generally called “permanent bonding.” Permanent bonding refers to such a property that a substrate and an underlying substrate, both being made of a silicone rubber such as PDMS, can be strongly adhered to each other without using an adhesive but by just performing a certain kind of surface modification; this property contributes to exhibiting an effective seal on micro-structures such as micro-channels and/or ports. In the permanent bonding of PDMS substrates, their mating surfaces are subjected to an appropriate treatment of surface modification and then the two substrates are superposed, with the mating surface of one substrate being placed in intimate contact with the mating surface of the other substrate, and the assembly is left to stand for a certain period of time, whereupon the two substrates can be easily adhered together. In other words, those parts of the substrates which correspond to the non-adhesive thin-film layers 11 and 12 are not permanently bonded, so pressure or other external force may be applied to inflate those portions in a balloon-like shape for creating a micro-channel and a micro-valve. Since the other parts of the substrates which have not been inflated are permanently bonded, the liquid or gas that is passed through the inflated portions will not leak to any other sites. As long as the ability to bond permanently to the silicone rubber intermediate substrate 7 is assured, it is of course possible to use the lower substrate 5 that is made of materials other than silicone rubbers such as PDMS and glass. Examples of such lower substrate include cellulose ester substrates, polyester substrates, polycarbonate substrates, polystyrene substrates, polyolefin substrates, etc.; specific examples of suitable materials include poly(ethylene terephthalate), poly(ethylene naphthalate), polyethylene, polypropylene, cellophane, cellulose diacetate, cellulose acetate butyrate, cellulose acetate propionate, cellulose acetate phthalate, cellulose triacetate, cellulose nitrate, poly(vinylidene chloride), poly(vinyl alcohol), ethylene-vinyl alcohol, polycarbonate, norbornene resin, poly(methylpentene), polyetherketone, polyimide, polyethersulfone, poly(etherketone imide), polyamide, fluoropolymer, nylon, poly(methyl methacrylate), poly(methyl acrylate), etc. Other materials that can be used to form the lower substrate 5 include poly(lactic acid) resins, poly(butylene succinate), nitrile rubber, hydrogenated nitrile rubber, fluorinated rubber, ethylene-propylene rubber, chloroprene rubber, acrylic rubber, butyl rubber, urethane rubber, chlorosulfonated polyethylene rubber, epichlorohydrin rubber, natural rubber, isoprene rubber, styrene-butadiene rubber, butadiene rubber, polysulfide rubber, norbornene rubber, and thermoplastic elastomers. These materials can be used either alone or in suitable admixture.

If these materials are not capable of permanent bonding by themselves, their surfaces to be adhered to the intermediate substrate 7 are subjected to such a surface treatment that they can be permanently bonded. Agents that can be used in this surface treatment include silicone compounds and titanium compounds and specific examples include: alkyl silanes such as dimethylsilane, tetramethylsilane, and tetraethylsilane; organosilicon compounds such as tetramethoxysilane, tetraethoxysilane, tetrapropoxysilane, dimethyldiethoxysilane, methyltrimethoxysilane, and ethyltriethoxysilane; silicon hydride compounds such as monosilane and disilane; silicon halide compounds such as dichlorosilane, trichlorosilane, and tetrachlorosilane; silazanes such as hexamethyldisilazane, and silicon compounds having functional groups introduced therein, as exemplified by vinyl, epoxy, styryl, methacryloxy, acryloxy, amino, ureido, chloropropyl, mercapto, sulfide, and isocyanate.

It is generally preferred that the thickness of the lower substrate 5 is within the range from 300 μm to 10 mm. If the thickness of the lower substrate 5 is less than 300 μm, it becomes difficult to maintain the overall mechanical strength of the micro-channel chip 1. If, on the other hand, the thickness of the lower substrate 5 exceeds 10 mm, the mechanical strength required of the micro-channel chip 1 is saturated and only diseconomy results.

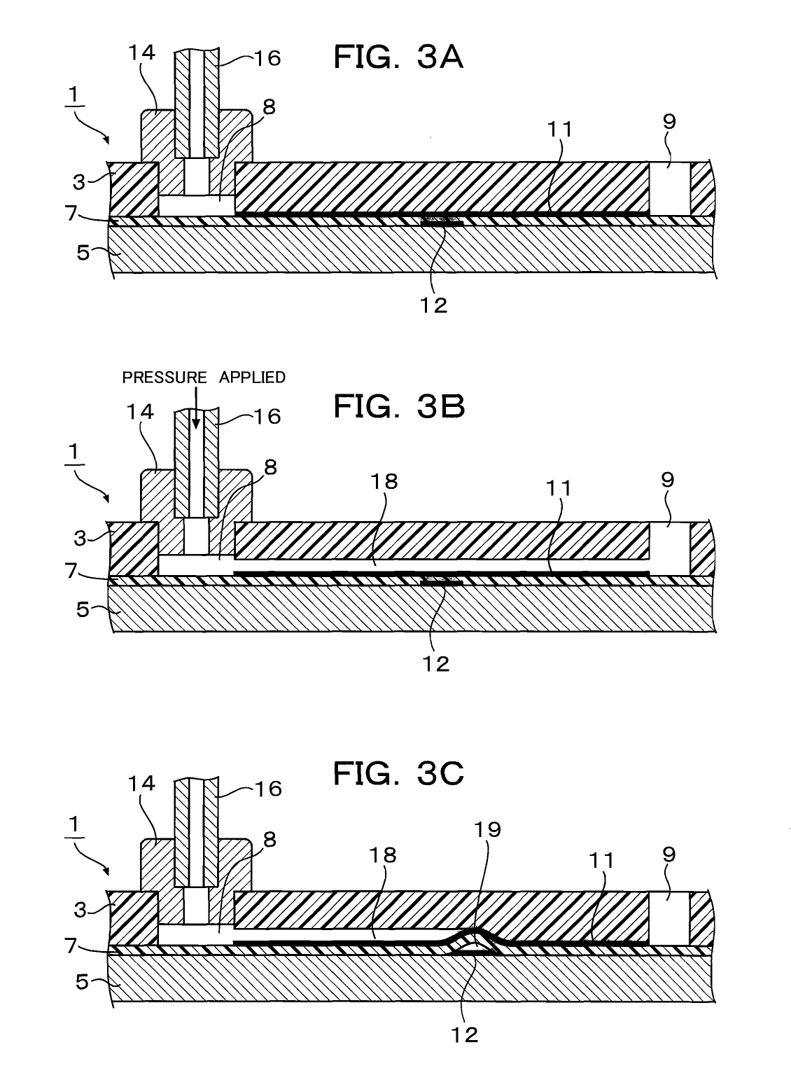

FIG. 3 is a set of partial outline sectional views showing an exemplary mode of using the micro-channel chip 1 of the present invention. As shown in FIG. 3A, the micro-channel chip 1 of the present invention has an adapter 14 provided in the opening of the port 8 which should help introduce a liquid or gas and a feed tube 16 is connected to this adapter 14. Needless to say, the shape of the adapter 14 is not limited to the illustrated example. Instead of a shape that permits partial insertion into the port, it may assume a shape that enables it to be directly secured to the upper substrate 3. Alternatively, the adapter 14 may be dispensed with and the feed tube 16 may be directly connected to the port. The adapter 14 may be formed of PDMS which can permanently bond to the upper substrate 3 which is made of PDMS but other materials can of course be employed. If the adapter 14 is not made of PDMS, a suitable adhesive may be employed to secure it to the upper substrate 3. The feed tube 16 is formed of a flexible material. For instance, a TEFLON (registered trademark) tube is preferred. The feed tube 16 can be secured to the adapter 14 by using a suitable adhesive. Although not shown, the other end of the feed tube 16 is connected to a suitable liquid feed supply means and/or pressure applying means (e.g. a micro-pump or syringe).

If a liquid of interest has been injected into the port 8, a gas (e.g. air) is forced through the feed tube 16 at high pressure (say, 10 kPa to 100 kPa). Alternatively, a liquid of interest is injected into the port 8 with a positive pressure being simultaneously applied. Then, as shown in FIG. 3B, only that part of the upper substrate 3 which corresponds to the non-adhesive thin-film layer for a micro-channel 11 is slightly inflated to separate from the upper surface of the intermediate substrate 7 to create a gap 18 that can function as a micro-channel, whereupon the liquid and/or gas within the port 8 can be transferred to the port 9.

Although not shown, the pressure supply port 13 is also fitted with an adapter to which a gas (air) feed tube is connected, and both the adapter and the gas feed tube may be of the same types as shown in FIG. 3A. Because of this design, if a gas (air) is forced into the pressure supply port 13 through the feed tube at high pressure (say, 10 kPa to 100 kPa), then, as shown in FIG. 3C, only that part of the intermediate substrate 7 which corresponds to the non-adhesive thin-film layer for a shutter channel 12 is slightly inflated to separate from the upper surface of the lower substrate 5 to block the overlying gap for a micro-channel 18. The gap formed as the result of inflating that part of the intermediate substrate 7 which corresponds to the non-adhesive thin-film layer for a shutter channel 12 is called a gap for a shutter channel 19. Since no air pressure is applied in the gap for a micro-channel 18 over the distance that ranges from the gap for a shutter channel 19 to the port 9, this part of the gap for a micro-channel 18 disappears and the initial deflated state is restored. In this way, the gap for a shutter channel 19 is capable of functioning as a micro-valve that opens or closes the gap for a micro-channel 18. As long as high-pressure air is forced into the gap for a shutter channel 19, the gap for a micro-channel 18 is kept blocked. In this case, the pressures to be applied to the respective ports should preferably satisfy such a relation that the pressure applied to the pressure supply port 13 is greater than the pressure applied to the port 8. If the relation is reversed and the pressure applied to the pressure supply port 13 is smaller than the pressure applied to the port 8, the gap for a shutter channel 19 is crushed by the gap for a micro-channel 18 and the latter cannot be completely blocked. Therefore, if the pressure applied in the pressure supply port 13 is reduced to zero, the state shown in FIG. 3B is restored, and if the pressure applied in the port 8 is reduced to zero, the state shown in FIG. 3A is restored.

Note, however, that the sequence of steps in using the micro-channel chip 1 of the present invention is by no means limited to the sequence shown in FIG. 3. Suppose, for example, the case where it has a plurality of micro-channel gaps 18; only a specified micro-channel gap may be blocked by the gap for a shutter channel 19 so that a liquid can be passed through the other micro-channel gaps 18. In another applicable mode of use, the gap for a shutter channel 19 is first created and the gap for a micro-channel 18 is then created just halfway down the gap 19.

In the foregoing embodiment, the non-adhesive thin-film layer for a micro-channel 11 is provided on the lower side of the upper substrate 3 whereas the non-adhesive thin-film layer for a shutter channel 12 is provided on the upper side of the lower substrate 5; however, this is not the sole embodiment of the present invention and another embodiment is possible. For instance, the non-adhesive thin-film layer for a micro-channel 11 may be provided on the upper side of the intermediate substrate 7 whereas the non-adhesive thin-film layer for a shutter channel 12 is provided on the lower side of the intermediate substrate 7; even this design brings about the same results as obtained by the embodiment shown in FIGS. 3A to 3C. If the non-adhesive thin-film layer for a micro-channel 11 and the non-adhesive thin-film layer for a shutter channel 12 are formed on opposite sides of the intermediate substrate 7 as described above, the time required to achieve alignment when providing the two non-adhesive thin-film layers to intersect each other can be eliminated.

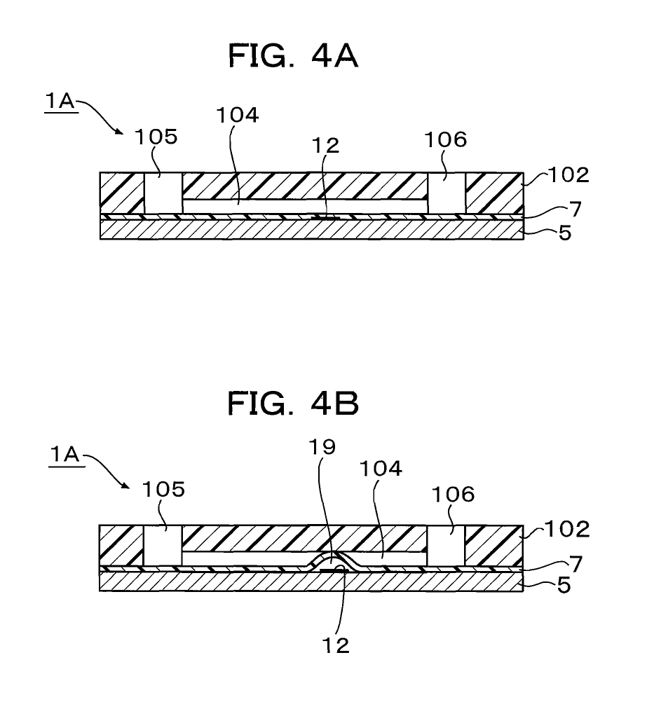

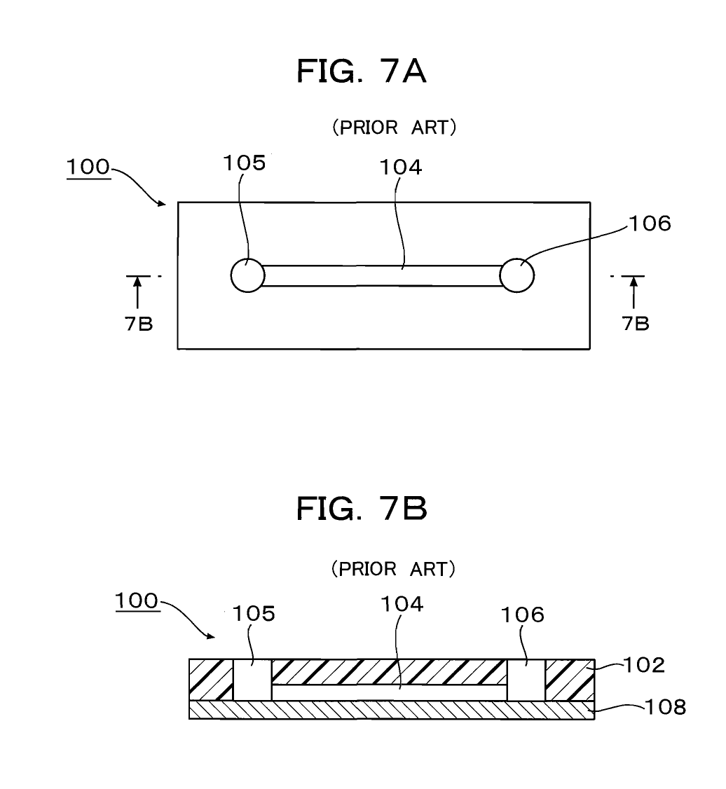

Another feature of the foregoing embodiment is that the gap for a micro-channel 18 in the upper substrate 3 is formed by providing the non-adhesive thin-film layer 11 but the present invention is by no means limited to this particular embodiment. The micro-channel itself may be of the same type as shown in FIGS. 7A and 7B, in which the conventional micro-channel chip 100 has the upper substrate 102 which in turn has the micro-channel 104 having a fixed cross-sectional shape. This alternative embodiment is shown in FIG. 4A. The upper substrate 102 having the micro-channel 104 with a fixed cross-sectional shape is made from a mold used in the conventional photolithography and placed on top of the lower substrate 5, with the intermediate substrate 7 being interposed. The micro-channel 104 typically has a rectangular cross-sectional shape but it may adopt any other shapes such as a semi-circular or a semi-elliptical shape. The non-adhesive thin-film layer for a shutter channel 12 is provided in a suitable area on the upper side of the lower substrate 5 or the lower side of the intermediate substrate 7 in such a way that it intersects the micro-channel 104. Although not shown, a pressure supply port that communicates with the non-adhesive thin-film layer for a shutter channel 12 is provided in the upper substrate 102. If pressure is applied through this pressure supply port, then, as shown in FIG. 4B, only that part of the intermediate substrate 7 which corresponds to the non-adhesive thin-film layer for a shutter channel 12 is slightly inflated to separate from the upper surface of the lower substrate 5 to form the gap for a shutter channel 19, which blocks the overlying micro-channel 104. In this way, the gap for a shutter channel 19 is also capable of functioning as a micro-valve that opens or closes the micro-channel 104 which has a fixed cross-sectional shape. In the case of using the intermediate substrate as a shutter, one might think of inflating the intermediate substrate in the conventional type of micro-channel; however, being a thin film, the intermediate substrate might inflate toward the shutter channel in the area where it intersects the micro-channel, thereby disturbing the flow in the micro-channel; this is not the case with the non-adhesive type channel according to the present invention.

The present invention is described below more specifically by reference to examples but it should be understood that the following examples are given for illustrative purposes only and are in no way intended to limit the scope of the present invention.

### EXAMPLE 1

### (1) Fabrication of Micro-Channel Chips

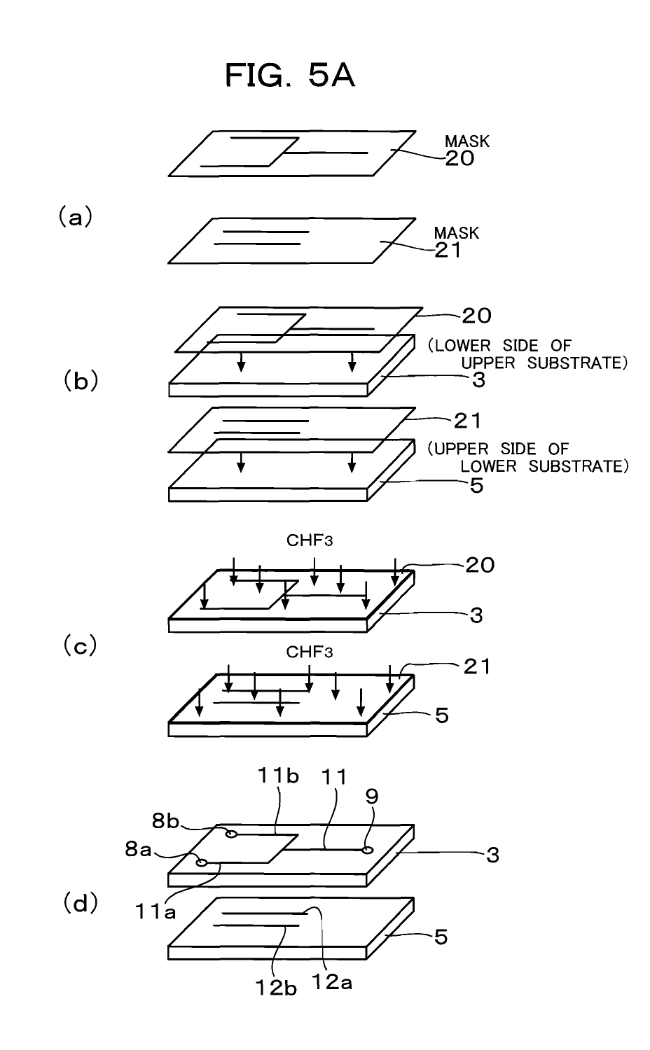

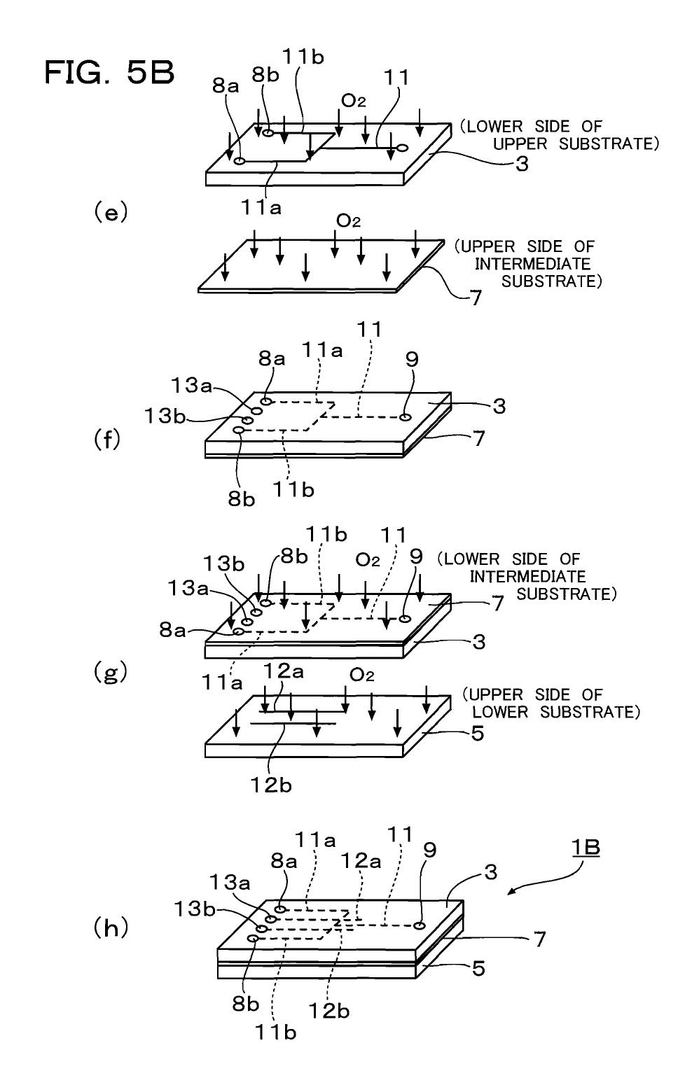

According to the flowchart shown in FIGS. 5A and 5B, a micro-channel chip 1B was fabricated. First, in step (a), two masks were prepared, each with a channel design punched through. Mask 20 was intended for the non-adhesive thin-film layer 11 and it was formed by cutting scores (feature size, 400 μm) through a PET film 0.025 mm thick to give a pattern of predetermined design. Mask 21 was intended for the non-adhesive thin-film layer 12 and it was formed by cutting scores (feature size, 400 μm) through a PET film 0.025 mm thick to give a pattern of predetermined design.

Next, in step (b), the mask 20 was placed on the lower side of the upper substrate 3 with a thickness of 3 mm that was made of silicone rubber (PDMS); the mask 20 was then attached to this upper substrate 3 by means of self-adsorption. The other mask 21 was placed on the upper side of the lower substrate 5 with a thickness of 3 mm that was made of silicone rubber (PDMS); the mask 21 was then attached to this lower substrate 5 by means of self-adsorption. Subsequently, in step (c), the two assemblies were housed within a reactive ion etching apparatus and a fluorocarbon (CHF3) was applied from above the masks. Then, in step (d) after the end of the CHF3 application, the assemblies were taken out of the reactive ion etching apparatus and stripped of the masks 20 and 21. As a result, a fluorocarbon (CHF3) film 1 μm thick that corresponded to the non-adhesive thin-film layer 11 had been formed on the lower side of the silicone-rubber made upper substrate 3 in a pattern that followed the mask pattern; similarly, a fluorocarbon (CHF3) film 1 μm thick that corresponded to the non-adhesive thin-film layer 12 had been formed on the upper side of the silicone-rubber made lower substrate 5 in a pattern that followed the mask pattern. Holes that should serve as ports 8a, 8b and 9 were bored through the upper substrate 3 in terminal end portions of the non-adhesive thin-film layer 11.

Subsequently, in step (e) in FIG. 5B, the lower side of the silicone-rubber made upper substrate 3 and the upper side of a 100 μm thick silicone-rubber made intermediate substrate 7 were subjected to a treatment for surface modification by an oxygen plasma in a reactive ion etching apparatus. Then, in step (f) following the treatment for surface modification, the lower side of the silicone-rubber made upper substrate 3 on which the thin patterned fluorocarbon (CHF3) film 11 had been formed was attached to the upper side of the silicone-rubber made intermediate substrate 7, whereby the silicone-rubber made upper substrate 3 was permanently bonded to the silicone-rubber made intermediate substrate 7. Further, in step (f), the assembly of the permanently bonded silicone-rubber made upper substrate 3 and intermediate substrate 7 had holes 13a and 13b, each with an inside diameter of 2 mm, cut through the silicone-rubber made lower substrate 5 in two positions corresponding to one end portion of the non-adhesive thin-film layer 12 on the silicon-rubber made lower substrate 5. Thereafter, in step (g), the assembly of the permanently bonded silicone-rubber made upper substrate 3 and intermediate substrate 7, as well as the silicone-rubber made lower substrate 5 were subjected to a treatment for surface modification by an oxygen plasma in the reactive ion etching apparatus; as for the assembly, the side where the intermediate substrate 7 was exposed (i.e., the lower side of the intermediate substrate 7) was surface modified and, as for the silicone-rubber made lower substrate 5, its upper side was surface modified. Finally, in step (h), the silicone-rubber made lower substrate 5 on which the thin patterned fluorocarbon (CHF3) film 12 had been formed was attached to the assembly of the silicone-rubber made upper substrate 3 and intermediate substrate 7, with the lower side of the intermediate substrate 7 being placed in contact with the upper side of the lower substrate 5, whereby the assembly of the silicone-rubber made upper substrate 3 and the silicone-rubber made intermediate substrate 7 was permanently bonded to the silicone-rubber made lower substrate 5 so as to complete the micro-channel chip 1B of the present invention. By repeating this procedure, four samples of the micro-channel chip 1B were prepared and they were respectively used in the following liquid feeding and control tests.

### (2) Liquid Feeding and Control Test 1

In the first sample of the micro-channel chip 1B prepared in (1) above, ports 8a and 8b were charged with 1 μL of the DNA staining solution Cyber Green I and examined for the occurrence of any fluorescence under a microscope. Since there was no DNA available at that time, no fluorescence was observed. Port 9 was charged with 10 μL of a solution of human genome (DNA) in TE and air pressure (positive pressure) was applied to the solution in port 9 by means of a syringe connected to the through-hole in an adapter. The pressure in the port 9 was gradually increased and at the point in time when it exceeded 50 kPa, the areas corresponding to the non-adhesive thin-film layers 11, 11a and 11b that were made of the thin patterned fluorocarbon (CHF3) film expanded and rose to create gaps that should serve as micro-channels, through which the solution in the port 9 was transferred toward the ports 8a and 8b, where the DNA solution mixed with the fluorescent reagent. Examination under a fluorescence microscope showed the emission of fluorescence from the fluorescent reagent that had intercalated into the DNA.

(3) Liquid Feeding and Control Test 2

In the second sample of the micro-channel chip 1B prepared in (1) above, ports 8a and 8b were charged with 1 μL of the DNA staining solution Cyber Green I and examined for the occurrence of any fluorescence under a microscope. Since there was no DNA available at that time, no fluorescence was observed. Port 9 was charged with 10 μL of a solution of human genome (DNA) in TE and air pressure (positive pressure) was applied to the solution in port 9 by means of a syringe connected to the through-hole in an adapter. At the same time, an air pressure of 100 kPa was applied and maintained in the pressure supply port 13a by means of a syringe connected to the through-hole in an adapter. The pressure in the port 9 was gradually increased and at the point in time when it exceeded 50 kPa, the areas corresponding to the non-adhesive thin-film layers 11 and 11b that were made of the thin patterned fluorocarbon (CHF3) film inflated to create gaps that should serve as micro-channels, through which the solution in the port 9 was transferred toward the port 8b, where the DNA solution mixed with the fluorescent reagent. Examination under a fluorescence microscope showed the emission of fluorescence from the fluorescent reagent that had intercalated into the DNA. However, the DNA solution was not transferred toward the port 8a and no fluorescence was observed. This is because the pressure of the air applied in the pressure supply port 13a was higher than that of the air applied in the port 9, thereby interrupting the non-adhesive thin-film layer 11a that established communication between the port 9 and the port 8a.

### (4) Liquid Feeding and Control Test 3

In the third sample of the micro-channel chip 1B prepared in (i) above, ports 8a and 8b were charged with 1 μL of the DNA staining solution Cyber Green I and examined for the occurrence of any fluorescence under a microscope. Since there was no DNA available at that time, no fluorescence was observed. Port 9 was charged with 10 μL of a solution of human genome (DNA) in TE and air pressure (positive pressure) was applied to the solution in port 9 by means of a syringe connected to the through-hole in an adapter. At the same time, an air pressure of 100 kPa was applied and maintained in the pressure supply port 13b by means of a syringe connected to the through-hole in an adapter. The pressure in the port 9 was gradually increased and at the point in time when it exceeded 50 kPa, the areas corresponding to the non-adhesive thin-film layers 11 and 11a that were made of the thin patterned fluorocarbon (CHF3) film inflated to create gaps that should serve as micro-channels, through which the solution in the port 9 was transferred toward the port 8a, where the DNA solution mixed with the fluorescent reagent. Examination under a fluorescence microscope showed the emission of fluorescence from the fluorescent reagent that had intercalated into the DNA. However, the DNA solution was not transferred toward the port 8b and no fluorescence was observed. This is because the pressure of the air applied in the pressure supply port 13b was higher than that of the air applied in the port 9, thereby interrupting the non-adhesive thin-film layer 11b that established communication between the port 9 and the port 8b.

### (5) Liquid Feeding and Control Test 4

In the fifth sample of the micro-channel chip 1B prepared in (1) above, ports 8a and 8b were charged with 1 μL of the DNA staining solution Cyber Green I and examined for the occurrence of any fluorescence under a microscope. Since there was no DNA available at that time, no fluorescence was observed. Port 9 was charged with 10 μL of a solution of human genome (DNA) in TE and air pressure (positive pressure) was applied to the solution in port 9 by means of a syringe connected to the through-hole in an adapter. At the same time, an air pressure of 100 kPa was applied and maintained in the pressure supply port 13a by means of a syringe connected to the through-hole in an adapter; what is more, an air pressure of 100 kPa was applied and maintained in the pressure supply port 13b by means of a syringe connected to the through-hole in an adapter. The pressure in the port 9 was gradually increased but the area corresponding to the non-adhesive thin-film layer 11 that was made of the thin patterned fluorocarbon (CHF3) film did not inflate at all and no gap was created that should serve as a micro-channel. Hence, the human genome (DNA) solution in the port 9 was transferred toward neither the port 8a nor 8b and no fluorescence was observed.

### (6) Discussion

From the foregoing results, it was confirmed that when the non-adhesive thin-film layer 11 was formed between the upper substrate 3 and the intermediate substrate 7, and the non-adhesive thin-film layer 12 between the lower substrate 5 and the intermediate substrate 7, in such a way that the two non-adhesive thin-film layers 11 and 12 would intersect in at least one position, not only a gap that would function as an inflated micro-channel but also a micro-valve that would interrupt the passage of a liquid through that gap functioning as the micro-channel could be created by a very inexpensive process, whereby it was possible to control the fluid in the gap functioning as the micro-channel.

### EXAMPLE 2

### (1) Fabrication of a Micro-Channel Chip

(a) Using a mold prepared by the usual procedure of photolithography, a silicone-rubber made upper substrate was formed; it was 3 mm thick and had a groove with a fixed rectangular shape as a micro-channel. The micro-channel (groove) was 400 μm wide and 50 μm deep. The lower side of the upper substrate and the upper side of a 100 μm thick silicone-rubber made intermediate substrate were subjected to a treatment for surface modification by the same method as in Example 1; the lower side of the upper substrate was attached to the upper side of the intermediate substrate, whereby the upper substrate was permanently bonded to the intermediate substrate. Three holes were bored through the permanently bonded assembly in predetermined positions.

(b) A mask was formed by cutting scores (feature size, 400 μm) through a PET film 0.025 mm thick to give a pattern of predetermined design. The mask was then placed on the upper side of a lower substrate with a thickness of 3 mm that was made of silicone rubber; the mask was then attached to this silicone-rubber made lower substrate by means of self-adsorption. The resulting assembly was housed within a reactive ion etching apparatus and a fluorocarbon (CHF3) was applied from above the mask. After the end of the CHF3 application, the assembly was taken out of the reactive ion etching apparatus and stripped of the mask. As a result, a fluorocarbon (CHF3) film 1 μm thick that would function as a non-adhesive thin-film layer had been formed on the upper side of the silicone-rubber made lower substrate in a pattern that followed the mask pattern. (c) The assembly of the permanently bonded silicone-rubber made upper substrate and intermediate substrate, as well as the silicone-rubber made lower substrate were subjected to a treatment for surface modification by the same method as in Example 1; as for the assembly, the side where the intermediate substrate was exposed (i.e., the lower side of the intermediate substrate) was surface modified and, as for the silicone-rubber made lower substrate, its upper side was surface modified; thereafter, the silicone-rubber made lower substrate on which the thin patterned fluorocarbon (CHF3) film had been formed was attached to the assembly of the silicone-rubber made upper substrate and intermediate substrate, with the lower side of the intermediate substrate being placed in contact with the upper side of the lower substrate, whereby the micro-channel chip of the present invention was completed.

### (2) Liquid Feeding and Control Test

In the micro-channel chip prepared in (1) above, one of the two ports to the micro-channel was charged with 1 μL of the DNA staining solution Cyber Green I and examined for the occurrence of any fluorescence under a microscope. Since there was no DNA available at that time, no fluorescence was observed. The other port was charged with 10 μL of a solution of human genome (DNA) in TE. With an air pressure of 100 kPa being applied and maintained by means of a syringe connected to the pressure supply port communicating with the non-adhesive thin-film layer formed between the lower substrate and the intermediate substrate, an air pressure of 50 kPa was applied by means of a syringe connected to one of the two ports to the micro-channel but no part of the solution in that port to the micro-channel was transferred and no fluorescence was observed. Thereafter, the application of pressure in the pressure supply port communicating with the non-adhesive thin-film layer formed between the lower substrate and the intermediate substrate was stopped, whereupon the liquid in one of the two ports to the micro-channel was transferred to the other port, where the DNA solution mixed with the fluorescent reagent. Examination under a fluorescence miqroscope showed the emission of fluorescence from the fluorescent reagent that had intercalated into the DNA.

### (3) Discussion

From the foregoing results, it was confirmed that even in the case of a micro-channel chip using an upper substrate having a micro-channel with a fixed rectangular shape, providing a non-adhesive thin-film layer between a lower substrate and an intermediate substrate and applying a sufficient pressure into a pressure supply port communicating with that non-adhesive thin-film layer to inflate a part of the intermediate layer to create a shutter channel enabled the micro-channel with a fixed rectangular shape to be blocked by the shutter channel formed of the inflated part of the intermediate substrate.

### EXAMPLE 3

### (1) Fabrication of a Micro-Channel Chip

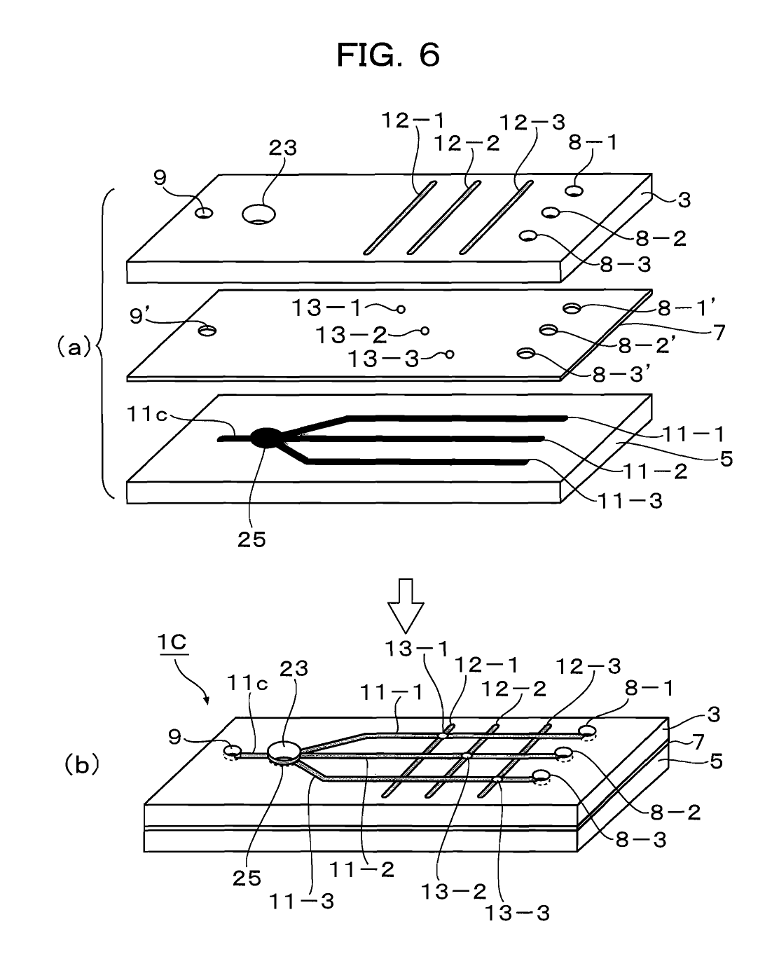

A micro-channel chip 1C of the design shown in FIG. 6 was fabricated. When a plurality of liquid chemicals are successively transferred through different channels into a single reaction chamber where they undergo intended reactions, the liquid chemical that has flowed through one channel into the reaction chamber might occasionally flow back into another channel. This phenomenon can be effectively prevented by using a micro-channel chip having the structure shown in FIG. 6. A PDMS upper substrate 3 having a thickness of 3 mm is provided with three ports 8-1, 8-2 and 8-3 that are through-holes for introducing a liquid. The upper substrate 3 is also provided with a through-hole 23 and a port 9; the through-hole 23 is for inflating an area that corresponds to a non-adhesive thin-film layer 25 in an enlarged region so as to create a reaction chamber, and the port 9 is a through-hole for discharging a liquid. Further, the upper substrate 3 is provided on the lower side with three non-adhesive thin-film layers for a shutter channel, 12-1, 12-2 and 12-3. A PDMS intermediate substrate 7 having a thickness of 100 μm is provided with through-holes 8-1′, 8-2′ and 8-3′ that respectively correspond to the liquid-introducing ports 8-1, 8-2 and 8-3 in the upper substrate 3, as well as a through-hole 9′ that corresponds to the liquid-discharging port 9 which is also a through-hole in the upper substrate 3. The intermediate substrate 7 is also provided with through-holes 13-1, 13-2 and 13-3 that should serve as pressure supply ports; these through-holes are provided in positions that correspond not only to the non-adhesive thin-film layers for a shutter channel 12-1, 12-2 and 12-3, respectively, on the lower side of the upper substrate 3 but also to non-adhesive thin-film layers for a micro-channel 11-1, 11-2 and 11-3, respectively, that are provided on the upper side of a lower substrate 5. The non-adhesive thin-film layers for a micro-channel 11-1, 11-2 and 11-3 on the upper side of the lower substrate 5 converge on the non-adhesive thin-film layer 25 in an enlarged region which is intended for creating a reaction chamber. The non-adhesive thin-film layer 25 in an enlarged region is also connected to a non-adhesive thin-film layer 11c for a micro-channel through which a liquid is to be discharged from the reaction chamber.

The upper substrate 3, the intermediate substrate 7 and the lower substrate 5 are attached to each other to make an integral assembly. An end portion of the non-adhesive thin-film layer for a micro-channel 11-1 communicates with the through-holes 8-1′ and 8-1; an end portion of the non-adhesive thin-film layer for a micro-channel 11-2 communicates with the through-holes 8-2′ and 8-2; and an end portion of the non-adhesive thin-film layer for a micro-channel 11-3 communicates with the through-holes 8-3′ and 8-3. An end portion of the non-adhesive thin-film layer for a micro-channel 11c through which a liquid is to be discharged from the reaction chamber communicates with the through-holes 9′ and 9. The through-hole 13-1 in the intermediate substrate 7 is positioned at the point where the non-adhesive thin-film layer for a shutter channel 12-1 on the lower side of the upper substrate 3 intersects with the non-adhesive thin-film layer for a micro-channel 11-1 on the upper side of the lower substrate 5; the through-hole 13-2 is positioned at the point where the non-adhesive thin-film layer for a shutter channel 12-2 on the lower side of the upper substrate 3 intersects with the non-adhesive thin-film layer for a micro-channel 11-2 on the upper side of the lower substrate 5; and the through-hole 13-3 is positioned at the point where the non-adhesive thin-film layer for a shutter channel 12-3 on the lower side of the upper substrate 3 intersects with the non-adhesive thin-film layer for a micro-channel 11-3 on the upper side of the lower substrate 5. Therefore, the non-adhesive thin-film layers for a shutter channel on the lower side of the upper substrate 3 are connected to the non-adhesive thin-film layers for a micro-channel on the upper side of the lower substrate 5 via through-holes in the intermediate substrate 7; however, those through-holes are covered by the upper substrate 3 and the lower substrate 5 and will not open to the atmosphere.

### (2) Liquid Feeding and Control Test

When a liquid colored in red was injected into the port 8-1 under pressure, the part that corresponded to the non-adhesive thin-film layer for a micro-channel 11-1 inflated to create a gap serving as a micro-channel but at the same time, a gap serving as a shutter channel was also created since the pressure was transmitted to the overlying the non-adhesive thin-film layer for a shutter channel 12-1 via the through-hole 13-1. By virtue of the through-hole 13-1, that gap serving as a shutter channel did not block the gap serving as a micro-channel that was created by inflating the part corresponding to the non-adhesive thin-film layer for a micro-channel 11-1 but only the gaps serving as micro-channels that were created by inflating the part corresponding to the non-adhesive thin-film layers for a micro-channel 11-2 and 11-3 were blocked since there were no through-holes at the points where those non-adhesive thin-film layers 11-2 and 11-3 intersected with the non-adhesive thin-film layer for a shutter channel 12-1. As a result, the red liquid injected into the port 8-1 under pressure stayed within the reaction chamber created by inflating the part corresponding to the non-adhesive thin-film layer 25 in an enlarged region and it could be effectively prevented from flowing back toward the ports 8-2 and 8-3 through micro-channels formed from the non-adhesive thin-film layers for a micro-channel 11-2 and 11-3. The same operation occurred when a red liquid was injected into the port 8-2 or 8-3 under pressure and it could be prevented from flowing back into a wrong channel since the gaps serving as micro-channels that were created from the non-adhesive thin-film layers for a micro-channel were blocked by gaps serving as shutter channels on account of the absence of through-holes at the points where those non-adhesive thin-film layers for a micro-channel intersected with the non-adhesive thin-film layer for a shutter channel. In this way, given a drive pressure source for transferring liquids, connecting non-adhesive thin-film layers for a micro-channel to non-adhesive thin-film layers for a shutter channel by means of through-holes makes it possible to control the liquid flows in gaps that serve as micro-channels provided in parallel to each other.

While the micro-channel chip of the present invention has been described above specifically with reference to its preferred embodiments, the present invention is by no means limited to those disclosed embodiments but various improvements and modifications are possible. For instance, a plurality of intermediate substrates may be inserted between the upper and lower substrates to fabricate a micro-channel chip of a multi-leveled or multi-layered structure. If desired, in addition to the micro-channels and fluid control mechanism, other elements such as electrodes and a heating mechanism can also be mounted on the same chip.

According to the present invention, a micro-channel chip having a fluid control mechanism can be produced with great ease and at low cost, which contributes to a marked improvement in its practical utility and economy. As a result, the micro-channel chip of the present invention finds effective and advantageous use in various fields including medicine, veterinary medicine, dentistry, pharmacy, life science, foods, agriculture, fishery, and police forensics. In particular, the micro-channel chip of the present invention is optimum for use in the fluorescent antibody technique and in-situ hybridization and can be used inexpensively in a broad range of applications including testing for immunological diseases, cell culture, virus fixation, pathological test, cytological diagnosis, biopsy tissue diagnosis, blood test, bacteriologic examination, protein analysis, DNA analysis, and RNA analysis.

1: A micro-channel chip comprising:
at least an upper substrate, a lower substrate, and an intermediate substrate interposed between the upper substrate and the lower substrate, at least one non-adhesive thin-film layer for a micro-channel being linearly formed on one mating side which is selected from among a mating sides side of the upper substrate and the intermediate substrate or a mating side of the lower substrate and the intermediate substrate,
at least two ports being provided on the non-adhesive thin-film layer for a micro-channel,
at least one non-adhesive thin-film layer for a shutter channel being linearly formed on the mating side opposite the mating side on which the non-adhesive thin-film layer for a micro-channel is formed such that it intersects the non-adhesive thin-film layer for a micro-channel by passing beneath or over the latter, with the intermediate substrate lying in between, and a pressure supply port for inflating that part of the substrate which corresponds to the non-adhesive thin-film layer for a shutter channel being provided in at least one area on the non-adhesive thin-film layer for a shutter channel.

2: A micro-channel chip comprising:
at least an upper substrate, a lower substrate, and an intermediate substrate interposed between the upper substrate and the lower substrate,
at least one groove-like micro-channel with a fixed cross-sectional shape being formed on one mating side selected from among a side of the upper substrate and the intermediate substrate or a mating side of the lower substrate and the intermediate substrate,
at least two ports being provided on the micro-channel,
at least one non-adhesive thin-film layer for a shutter channel being linearly formed on the mating side opposite the mating side on which the micro-channel is formed such that it intersects the micro-channel by passing beneath or over the latter, with the intermediate substrate lying in between, and a pressure supply port for inflating that part of the substrate which corresponds to the non-adhesive thin-film layer for a shutter channel being provided in at least one area on the non-adhesive thin-film layer for a shutter channel.

3: The micro-channel chip according to claim 1, wherein the linear, non-adhesive thin-film layer for a micro-channel further includes, halfway down it, at least one enlarged region having at least one planar shape that is selected from the group consisting of a circular, an elliptical, a rectangular, and a polygonal shape.

4: The micro-channel chip according to claim 1, wherein the linear, non-adhesive thin-film layer for a micro-channel is formed on the upper side of the intermediate substrate and the non-adhesive thin-film layer for a shutter channel is formed on the lower side of the intermediate substrate.

5: The micro-channel chip according to claim 1, wherein the upper substrate and the intermediate substrate are made of silicone rubber and the lower substrate is made of at least one of silicone rubber and glass.

6: A process for producing the micro-channel chip according to claim 1, wherein at least one of the linear, non-adhesive thin-film layer for a micro-channel and the non-adhesive thin-film layer for a shutter channel is formed by depositing on a substrate surface a thin film of a fluorocarbon (CHF3) through a mask having a desired through-pattern in the presence of the fluorocarbon using a reactive ion etching system (RIE).

7: A process for producing the micro-channel chip according to claim 1, wherein at least one of the linear, non-adhesive thin-film layer for a micro-channel and the non-adhesive thin-film layer for a shutter channel is formed by printing on a substrate surface.
